(19) United States
(12) Patent Application Publication
(10) Pub. No.: US 2020/0266475 A1
(43) Pub. Date: Aug. 20, 2020

(54) ELECTRODE PLATE AND BATTERY USING THE SAME

(71) Applicant: Ningde Amperex Technology Ltd., Ningde (CN)

(72) Inventors: Juan Jin, Ningde (CN); Fei Wu, Ningde (CN); XinBing Chen, Ningde (CN)

(21) Appl. No.: 16/361,505

(22) Filed: Mar. 22, 2019

(30) Foreign Application Priority Data
Feb. 14, 2019 (CN) 201910114956.7

(51) Int. Cl. H01M 10/04; H01M 10/653

(52) U.S. Cl. CPC H01M 10/045; H01M 10/653

(57) ABSTRACT

An electrode plate includes a current collector and an active layer formed on the current collector. The current collector includes a first end portion and a second end portion facing away from the first end portion along a length direction. The active layer comprises an active material, an amount of the active material in the active layer increases from the first end portion toward the second end portion along the length direction. The disclosure also provides a battery using the electrode plate.

### FIELD

The subject matter herein generally relates to an electrode plate and a battery using the electrode plate.

### BACKGROUND

Due to a battery's high operating voltage, high energy density, low self-discharge and long service life, the battery is an ideal energy source for instruments and meters, as well as the preferred power source for automotive electronics. However, the battery generates heat. Especially when the battery is charged and discharged at a high rate, the cells of the battery can generate large amount of heat. A temperature difference between the inside and the outside of the cells can be large, which will affect the stability and service life of the battery.

### SUMMARY

What is needed, is an electrode plate and a battery using the electrode plate. The electrode plate can balance a temperature difference between an interior of the battery and an exterior of the battery and improve a service life of the battery.

An electrode plate includes a current collector and an active layer on the current collector. The current collector includes a first end portion and a second end portion facing away from the first end portion along a length direction of the current collector. The active layer includes an active material. An amount of the active material in the active layer increases from the first end portion toward the second end portion along the length direction.

A battery includes a first electrode plate, a second electrode plate and a separator sandwiched between the first electrode plate and the second electrode plate. The first electrode plate includes a current collector and an active layer on the current collector. The current collector includes a first end portion and a second end portion facing away from the first end portion along a length direction of the current collector. The active layer includes an active material. An amount of the active material in the active layer increases from the first end portion toward the second end portion along the length direction. The second electrode plate and the separator are wound along the length direction to form an electrode assembly. The electrode assembly includes a center. The first end portion is located at an interior of the electrode assembly near the center, and the second end portion is located at an exterior of the electrode assembly away from the center.

The electrode plate of the present disclosure is designed to gradually increase the amount of the active material in the active layer from the first end portion toward the second end portion along the length direction according to different inner and outer heat dissipation environments of the battery, thereby reducing a heat generation inside the battery, balancing a temperature difference between the interior of the battery and an exterior of the battery and improving a service life of the battery.

### BRIEF DESCRIPTION OF THE DRAWINGS

Implementations of the present disclosure will now be described, by way of embodiments, with reference to the attached figures.

FIG. 1 is a cross-sectional view of an embodiment of an electrode plate.

FIG. 2 is a cross-sectional view of an embodiment of an electrode plate.

FIG. 3 is a cross-sectional view of an embodiment of an electrode plate.

FIG. 4 is a cross-sectional view of an embodiment of an electrode plate.

FIG. 5 is a cross-sectional view of an embodiment of an electrode plate.

FIG. 6 is a cross-sectional view of an embodiment of an electrode plate.

FIG. 7 is a cross-sectional view of an embodiment of an electrode plate.

FIG. 8 is a cross-sectional view of an embodiment of an electrode plate.

FIG. 9 is a cross-sectional view of an embodiment of an electrode assembly.

FIG. 10 is a diagram of an embodiment of a battery.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

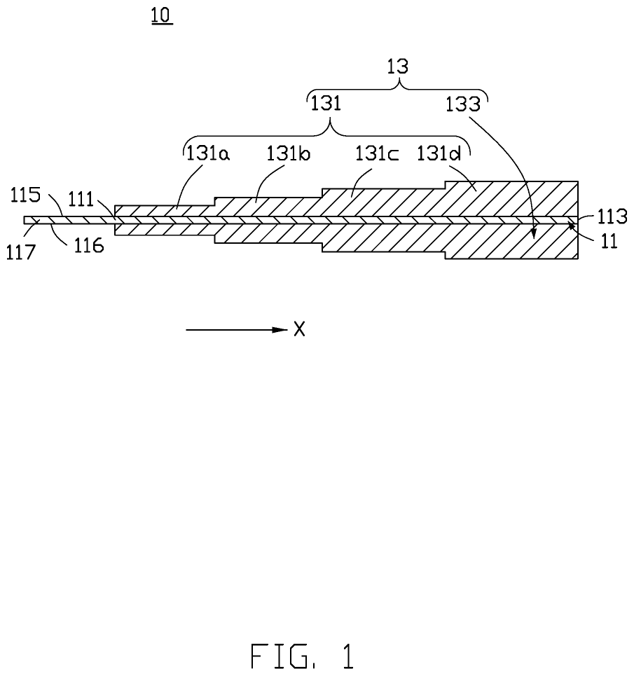

FIG. 1 illustrates an embodiment of an electrode plate 10. The electrode plate 10 includes a current collector 11 and an active layer 13 formed on the current collector 11. The current collector 11 includes a first end portion 111 and a second end portion 113 facing away from the first end portion 111, along a length direction X of the current collector 11. The active layer 13 includes an active material. An amount of the active material in the active layer 13 gradually increases from the first end portion 111 toward the second end portion 113 along the length direction X.

The current collector 11 includes a first surface 115 and a second surface 116 facing away from the first surface 115. Each of the first surface 115 and the second surface 116 is connected to the first end portion 111 and the second end portion 113.

The active layer 13 includes a first active layer 131 and a second active layer 133. The first active layer 131 is formed on the first surface 115. The second active layer 133 is formed on the second surface 116.

In at least one embodiment, referring to FIGS. 1, 2, 3 and 4, along the length direction X, a thickness of the active layer 13 gradually increases from an end of the active layer 13 adjacent to the first end portion 111 toward an end of the active layer 13 adjacent to the second end portion 113. The amount of the active material in the active layer 13 gradually increases along the length direction X as the thickness of the active layer 13 increases. That is, the amounts of the active material corresponding to different regions of different thickness of the active layer 13 are different.

In at least one embodiment, the first active layer 131 includes N parts including a first part 131a, a second part 131b, a third part 131c . . . and an N-th part. Wherein N is a natural number greater than 1. The first part 131a, the second part 131b, the third part 131c . . . and the N-th part are sequentially connected along the length direction X. The first part 131a is adjacent to the first end portion 111. The N-th part is adjacent to the second end portion 113. A thickness of the N-th part is greater than a thickness of the (N−1)-th part. That is, the thickness of the first active layer 131 increases in a stepwise manner from an end of the first active layer 131 adjacent to the first end portion 111 toward an end of the first active layer 131 adjacent to the second end portion 113 along the length direction X. In at least one embodiment, the thickness of each of the parts is uniform.

In a first embodiment, referring to FIG. 1, the first active layer 131 includes a first part 131a, a second part 131b, a third part 131c, and a fourth part 131d. The thickness of the first part 131a is uniform. The thickness of the second part 131b is uniform. The thickness of the third part 131c is uniform. The thickness of the fourth part 131d is uniform. The thickness of the first part 131a is less than the thickness of the second part 131b, the thickness of the second part 131b is less than the thickness of the third part 131c, and the thickness of the third part 131c is less than the thickness of the fourth part 131d.

Any two adjacent parts of the first part 131a, the second part 131b, the third part 131c, and the fourth part 131d are vertically connected.

A structure of the second active layer 133 is the same as and corresponds to that of the first active layer 131.

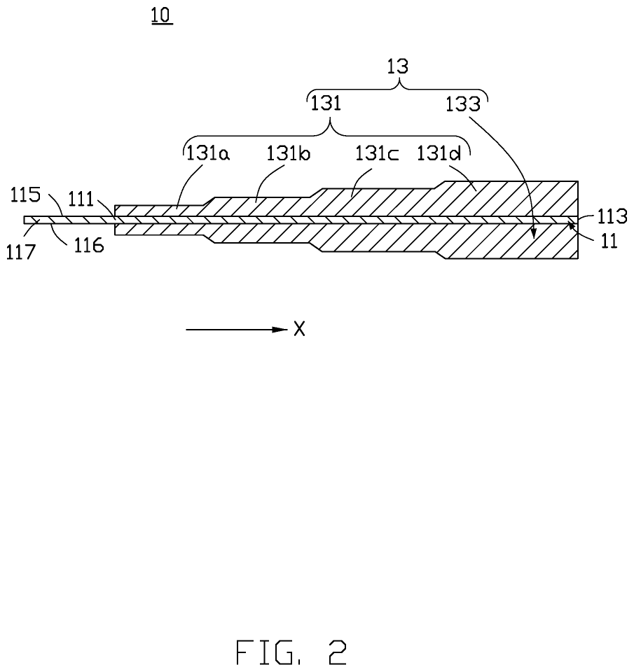

FIG. 2 shows an electrode plate different from the electrode plate of the embodiment shown in FIG. 1. A joint between the adjacent parts including the first part 131a, the second part 131b, the third part 131c, and the fourth part 131d of the electrode plate shown in FIG. 2 has two ends. The thickness of the joint increases linearly from one end of the joint adjacent to the first end portion 111 toward another end of the joint adjacent to the second end portion 113 along the length direction X. In another embodiment, the joint may be arcuate.

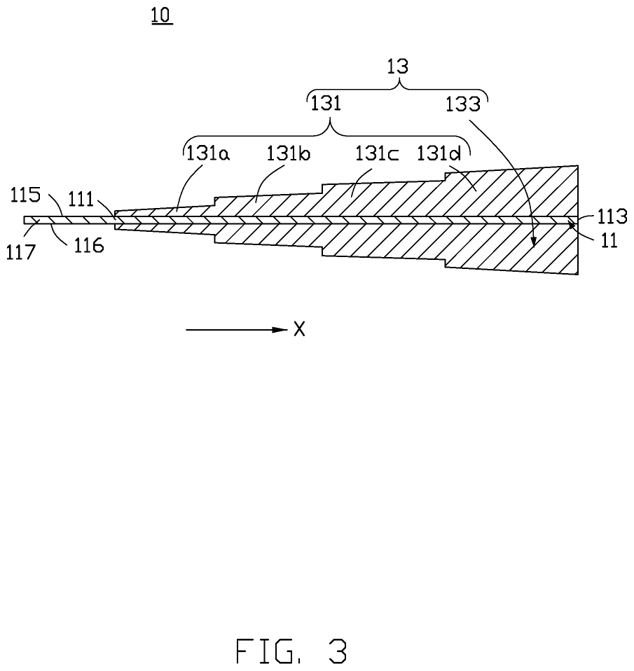

FIG. 3 shows an electrode plate different from the electrode plate of the embodiment shown in FIG. 1. The thickness of each of the first part 131a, the second part 141b, the third part 131c, and the fourth part 131d increases linearly from one end of the part adjacent to the first end portion 111 toward another end of the part adjacent to the second end portion 113 along the length direction X.

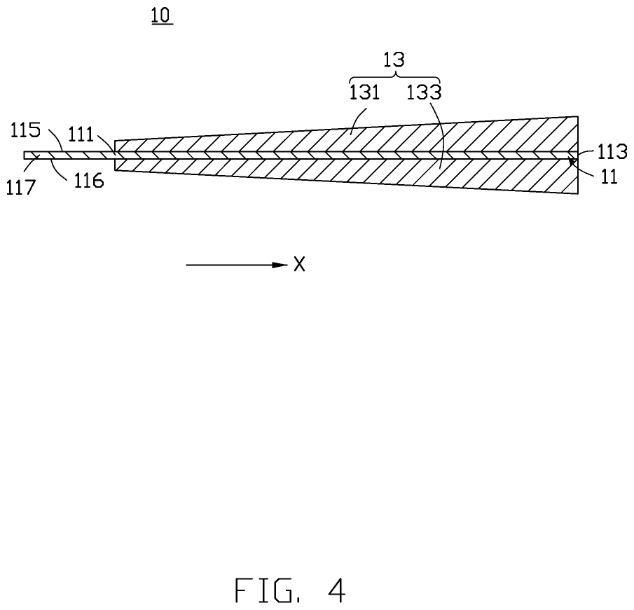

In an embodiment, referring to FIG. 4, the thickness of the first active layer 131 increases linearly from the end adjacent to the first end portion 111 toward the end adjacent to the second end portion 113 along the length direction X. The second active layer 133 mirrors the first active layer 131 in thickness.

In the above embodiments, the thickness of the first active layer 131 increases from the end of the first active layer 131 adjacent to the first end portion 111 toward the end of the first active layer 131 adjacent to the second end portion 113 along the length direction X. The thickness of the second active layer 133 increases from an end of the second active layer 133 adjacent to the first end portion 111 toward an end of the second active layer 133 adjacent to the second end portion 113 along the length direction X.

In another embodiment, the structure of the second active layer 133 can be different from that of the first active layer 131.

In at least one embodiment, an amount of the active material in the first active layer 131 and an amount of the active material in the second active layer 133 gradually increase from the end of the active layer 13 adjacent to the first end portion 111 toward the end of the active layer 13 adjacent to the second end portion 113 along the length direction X, respectively. The amount of the active material in the first active layer 131 corresponding to any area of the current collector 11 is less than the amount of the active material in the second active layer 133 corresponding to the same area of the current collector 11.

In at least one embodiment, the amount of the active material in the active layer 13 can gradually increase from the end of the active layer 13 adjacent to the first end portion 111 toward the end of the active layer 13 adjacent the second end portion 113 along the length direction X, and the thickness of the active layer 13 may be uniform or varied.

In at least one embodiment, the active layer 13 may further include thermally conductive materials. The thermally conductive materials are mixed with the active material. An amount of the thermally conductive materials in the active layer 13 gradually decreases from the end of the active layer 13 adjacent to the first end portion 111 toward the end of the active layer 13 adjacent to the second end portion 113 along the length direction X.

The thermally conductive materials may be at least one of graphene and graphene oxide, or may be other commonly used thermally conductive materials in the art.

In at least one embodiment, in the active layer 13, a mass ratio of the thermally conductive materials and the active material is 10:90 to 0.1:99.9. Along the length direction X, the mass ratio gradually decreases from the end of the active layer 13 adjacent to the first end portion 111 toward the end of the active layer 13 adjacent to the second end portion 113. The amount of the thermally conductive materials in the active layer 13 may decrease in a stepwise manner, linearly, or in other ways.

In at least one embodiment, the amount of the thermally conductive materials in the active layer 13 decreases in a stepwise manner from the end of the active layer 13 adjacent to the first end portion 111 toward the end of the active layer 13 adjacent to the second end portion 113 along the length direction X. The mass ratio of the thermally conductive materials and the active material in an area of the active layer 13 closest to the first end portion 111 is 5:95 to 10:90. The mass ratio of the thermally conductive materials and the active material in an area of the active layer 13 closest to the second end portion 113 is 0.1:99.9 to 1:99.

In at least one embodiment, the amount of the thermally conductive materials may decrease as the thickness of the active layer 13 increases. That is, the amounts of the thermally conductive materials corresponding to different regions of the active layer 13 of different thickness are different.

In at least one embodiment, an amount of the thermally conductive materials in the first active layer 131 and an amount of the thermally conductive materials in the second active layer 133 gradually decrease from the end of the active layer 13 adjacent to the first end portion 111 toward the end of the active layer 13 adjacent to the second end portion 113 along the length direction X, respectively. The amount of the thermally conductive materials in the first active layer 131 corresponding to any area of the current collector 11 is greater than the amount of the thermally conductive materials in the second active layer 133 corresponding to the same area of the current collector 11.

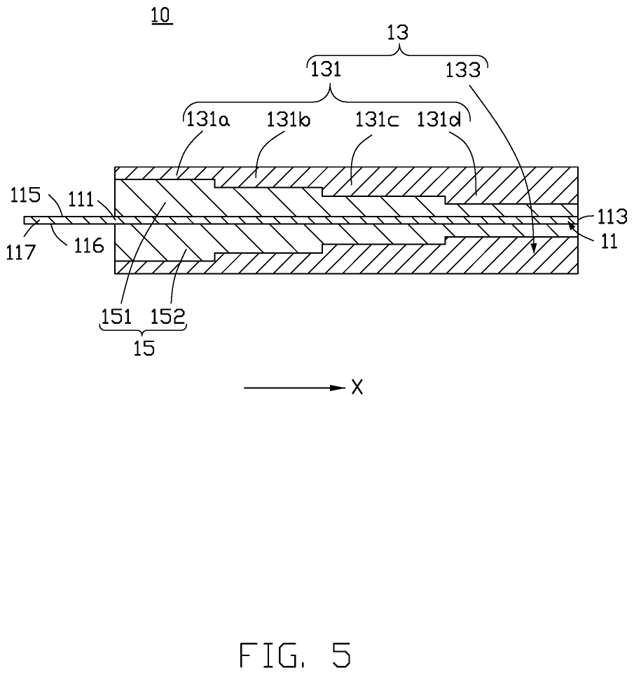

In at least one embodiment, referring to FIGS. 5, 6, 7 and 8, the electrode plate 10 may further include a thermally conductive layer 15 sandwiched between the active layer 13 and the current collector 11. The thermally conductive layer 15 defines a profile matching a profile of the active layer 13. The thermally conductive layer 15 includes thermally conductive materials. An amount of the thermally conductive materials in the thermally conductive layer 15 gradually decreases from an end of the thermally conductive layer 15 adjacent to the first end portion 111 toward an end of the thermally conductive layer 15 adjacent to the second end portion 113 along the length direction X.

The thermally conductive layer 15 further includes an adhesive mixed with the thermally conductive materials. The adhesive may be an aqueous adhesive or an oily adhesive. The aqueous adhesive may be selected from a group consisting of butadiene styrene rubber, carboxymethyl cellulose, water-borne acrylic resin, and any combination thereof. The oily adhesive may be selected from a group consisting of polyvinylidene fluoride, ethylene-vinyl acetate copolymer, polyvinyl alcohol, and any combination thereof.

In at least one embodiment, a thickness of the thermally conductive layer 15 may gradually decrease from an end of the thermally conductive layer 15 adjacent to the first end portion 111 toward an end of the thermally conductive layer 15 adjacent to the second end portion 113 along the length direction X. The amount of the thermally conductive materials in the thermally conductive layer 15 gradually decreases along the length direction X as the thickness of the thermally conductive layer 15 decreases. That is, the amounts of the thermally conductive materials corresponding to different regions of the thermally conductive layer 15 of different thickness are different.

FIG. 5 shows an electrode plate different from the electrode plate of the embodiment shown in FIG. 1 in that the electrode plate 10 further includes the thermally conductive layer 15 sandwiched between the active layer 13 and the current collector 11. The thickness of the thermally conductive layer 15 gradually decreases in a stepwise manner from an end of the thermally conductive layer 15 adjacent to the first end portion 111 toward an end of the thermally conductive layer 15 adjacent to the second end portion 113 along the length direction X. As a result, a surface of the active layer 13 facing away from the current collector 11 is flat.

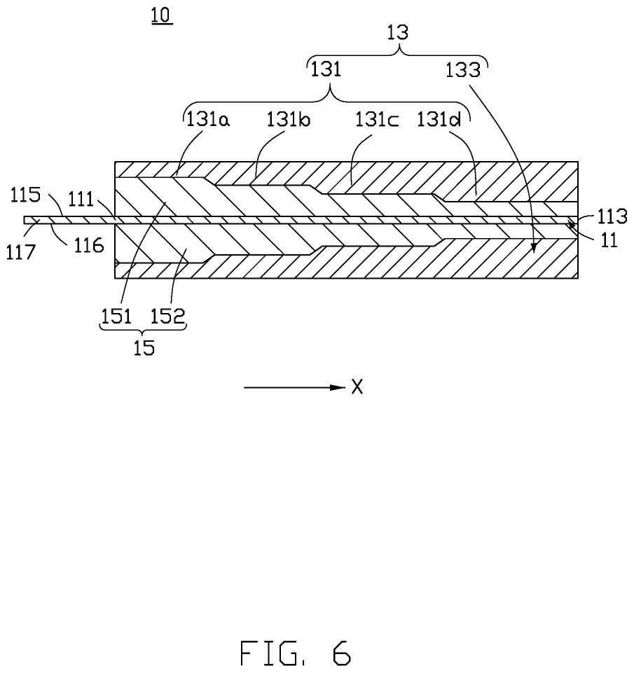

FIG. 6 shows an electrode plate different from the electrode plate of the embodiment shown in FIG. 2 in that the electrode plate 10 further includes the thermally conductive layer 15 sandwiched between the active layer 13 and the current collector 11 and the surface of the active layer 13 facing away from the current collector 11 is flat.

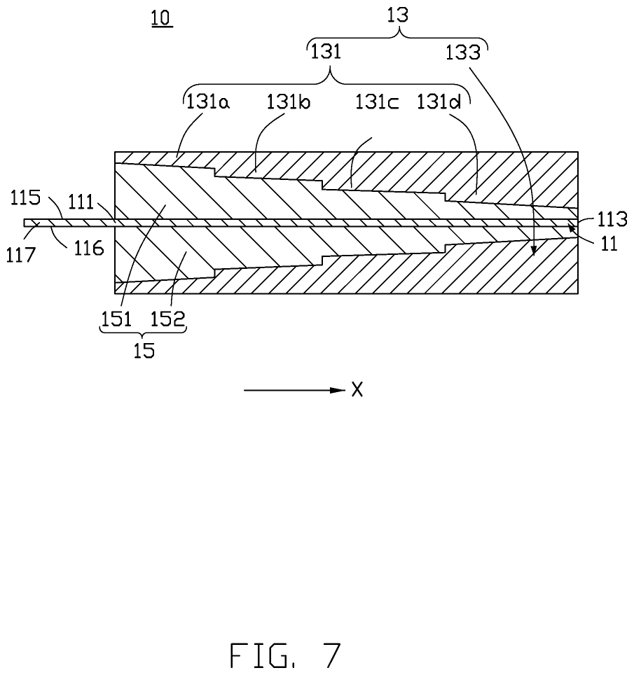

FIG. 7 shows an electrode plate different from the electrode plate of the embodiment shown in FIG. 3 in that the electrode plate 10 further includes the thermally conductive layer 15 sandwiched between the active layer 13 and the current collector 11 and the surface of the active layer 13 facing away from the current collector 11 is flat.

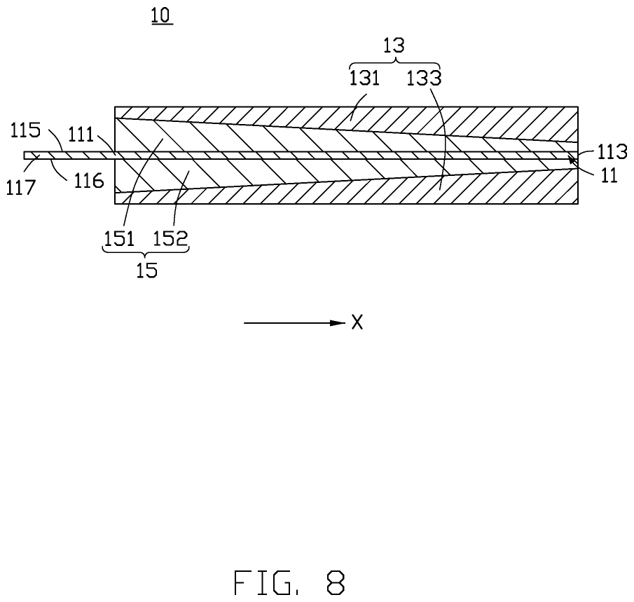

FIG. 8 shows an electrode plate different from the electrode plate of the embodiment shown in FIG. 4 in that the electrode plate 10 further includes the thermally conductive layer 15 sandwiched between the active layer 13 and the current collector 11 and the surface of the active layer 13 facing away from the current collector 11 is flat.

In at least one embodiment, the thermally conductive layer 15 is sandwiched between the active layer 13 and the current collector 11, but the surface of the active layer 13 facing away from the current collector 11 may be uneven.

In at least one embodiment, the amount of the thermally conductive materials in the thermally conductive layer 15 can be gradually decrease from the end of the thermally conductive layer 15 adjacent to the first end portion 111 toward the end of the thermally conductive layer 15 adjacent the second end portion 113 along the length direction X, and the thickness of the thermally conductive layer 15 may be uniform or varied.

In at least one embodiment, the thermally conductive layer 15 includes a first thermally conductive layer 151 and a second thermally conductive layer 152. The first thermally conductive layer 151 is sandwiched between the first active layer 131 and the first surface 115. The second thermally conductive layer 152 is sandwiched between the second active layer 133 and the second surface 116. An amount of the thermally conductive materials in the first thermally conductive layer 151 and an amount of the thermally conductive materials in the second thermally conductive layer 152 gradually decrease from the end of the thermally conductive layer 15 adjacent to the first end portion 111 toward the end of the thermally conductive layer 15 adjacent to the second end portion 113 along the length direction X, respectively. The amount of the thermally conductive materials in the first thermally conductive layer 151 corresponding to any area of the current collector 11 is greater than the amount of the thermally conductive materials in the second thermally conductive layer 152 corresponding to the same area of the current collector 11.

In at least one embodiment, the current collector 11 may further include an uncoated portion 117 where the current collector 11 is not coated with the active material, or a single-side coated portion (not shown) where only one side of the current collector 11 is coated with the active material. The uncoated portion 117 or single-side coated portion may extend from the first end portion 111 or extend from the second end portion 113.

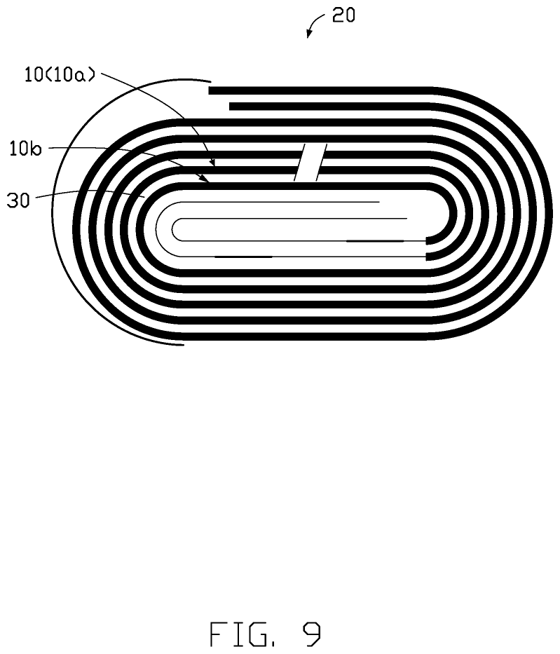

FIG. 9 illustrates an embodiment of an electrode assembly 20 using the electrode plate 10. The electrode assembly 20 is formed by winding a first electrode plate 10a and a second electrode plate 10b. The first electrode plate 10a can be any of the embodiment described above and as shown in FIGS. 1-8. The first electrode plate 10a is wound along the length direction X. The electrode assembly 20 includes a center (not shown). Wherein the first end portion 111 is located at an exterior of the electrode assembly 20 near the center of the electrode assembly 20, and the second end portion 113 is located at an interior of the electrode assembly 20 away from the center of the electrode assembly 20. Because the amount of the active material in the active layer 13 gradually increases from the first end portion 111 toward the second end portion 113 along the length direction X, heat generated by the electrode plate 10 adjacent to the interior of the electrode assembly 20 is less than heat generated by the electrode plate 10 adjacent to the exterior of the electrode assembly 20, thereby reducing a temperature difference between the interior of the electrode assembly 20 and the exterior of the electrode assembly 20. In addition, because the amount of the thermally conductive materials in the electrode plate 10 gradually increases from the first end portion 111 toward the second end portion 113 along the length direction X, heat generated by the electrode plate 10 near the interior can be dissipated faster than heat generated near the exterior. Hence, the temperature difference between the interior of the electrode assembly 20 and the exterior of the electrode assembly 20 can be further reduced.

In at least one embodiment, the first surface 115 of the current collector 11 faces a center of the electrode assembly 20, and the second surface 116 of the current collector 11 faces away from the center of the electrode assembly 20. The amount of the active material in the first active layer 131 corresponding to any area of the current collector 11 is less than the amount of the active material in the second active layer 133 corresponding to the same area of the current collector 11, and/or the amount of the thermally conductive materials in the first active layer 131 corresponding to any area of the current collector 11 is greater than the amount of the thermally conductive materials in the second active layer 133 corresponding to the same area of the current collector 11. As a result, the temperature difference between the interior of the electrode assembly 20 and the exterior of the electrode assembly 20 can be further reduced.

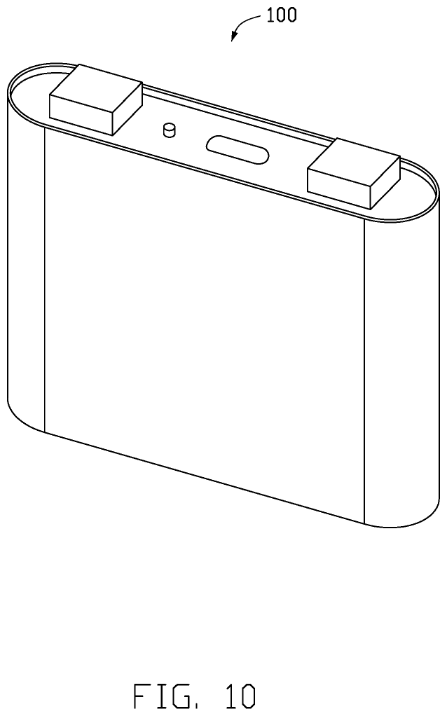

In at least one embodiment, when the electrode plate 10 is wound, the active material in a region of the electrode plate 10 corresponding to a same circle of the electrode assembly 20 is evenly contributed, and amounts of the active material in different regions of the electrode plate 10 corresponding to different circles of the electrode assembly 20 are different. In an embodiment, the electrode assembly 20 includes a first circle and a second circle extending from an end portion of the first circle along the length direction X. An amount of the active material of any region of the electrode plate 10 in the first circle of the electrode assembly is the same, and an amount of the active material of any region of the electrode plate 10 in the second circle of the electrode assembly is the same. The amount of the active material in the first circle of the electrode assembly is different from the amount of the active material in the second circle of the electrode assembly. The electrode assembly 20 can be applied in a battery 100 (shown in FIG. 10). The electrode plate 10 used in the electrode assembly 20 can be a positive electrode plate or a negative electrode plate. The battery 100 further includes a separator 30 sandwiched between the first electrode plate 10a and the second electrode plate 10b.

Because the temperature difference between the interior of the electrode assembly 20 and the exterior of the electrode assembly 20 is reduced, a loss of energy density of the battery 100 can be reduced, and a service life of the battery 100 can be prolonged.

The electrode plate 10 can decrease internal overheating of the battery during high rate charging and discharging and performance loss caused by temperature differences between inside and outside of the battery. So the stability and safety of the battery can be improved, and the service life of the battery can be prolonged.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An electrode plate comprising:
a current collector comprising a first end portion and a second end portion facing away from the first end portion along a length direction of the current collector; and
an active layer on the current collector;
wherein the active layer comprises an active material, and an amount of the active material in the active layer increases from the first end portion toward the second end portion along the length direction.

2. The electrode plate of claim 1, wherein a thickness of the active layer increases from the first end portion toward the second end portion.

3. The electrode plate of claim 1, wherein the active layer further comprises a thermally conductive material mixed with the active material, and an amount of the thermally conductive material in the active layer decreases from the first end portion toward the second end portion along the length direction.

4. The electrode plate of claim 1, wherein the electrode plate further comprises a thermally conductive layer sandwiched between the active layer and the current collector, the thermally conductive layer comprises a thermally conductive material, and an amount of the thermally conductive material in the thermally conductive layer decreases from the first end portion toward the second end portion along the length direction.

5. The electrode plate of claim 4, wherein a thickness of the thermally conductive layer decreases from the first end portion toward the second end portion along the length direction.

6. The electrode plate of claim 1, wherein the current collector comprises a first surface and a second surface facing away from the first surface; the active layer comprises a first active layer formed on the first surface and a second active layer formed on the second surface;
an amount of the active material in the first active layer increases from the first end portion toward the second end portion along the length direction, an amount of the active material in the second active layer increases from the first end portion toward the second end portion along the length direction; and,
the amount of the active material in the first active layer on a corresponding area of the current collector is less than the amount of the active material in the second active layer on the corresponding area of the current collector.

7. The electrode plate of claim 6, wherein each of the first active layer and the second active layer comprises a thermally conductive material mixed with the active material;
the thermally conductive material in the first active layer decreases from the first end portion toward the second end portion along the length direction, the thermally conductive material in the second active layer decreases from the first end portion toward the second end portion along the length direction;
the amount of the thermally conductive material in the first active layer on a corresponding area of the current collector is greater than the amount of the thermally conductive material in the second active layer on the corresponding area of the current collector.

8. The electrode plate of claim 6, wherein the electrode plate further comprises a first thermally conductive layer and a second thermally conductive layer;
the first thermally conductive layer is sandwiched between the first active layer and the first surface, the second thermally conductive layer is sandwiched between the second active layer and the second surface;
each of the first thermally conductive layer and the second thermally conductive layer comprises a thermally conductive material, an amount of the thermally conductive material in the first thermally conductive layer decreases from the first end portion toward the second end portion along the length direction, an amount of the thermally conductive material in the second thermally conductive layer decreases from the first end portion toward the second end portion along the length direction; and,
the amount of the thermally conductive material in the first thermally conductive layer on a corresponding area of the current collector is less than the amount of the thermally conductive material in the second thermally conductive layer on the corresponding area of the current collector.

9. The electrode plate of claim 1, wherein a thickness of the active layer increases in a stepwise manner from an end of the active layer adjacent to the first end portion toward an end of the active layer adjacent to the second end portion along the length direction.

10. A battery comprising:
a first electrode plate comprising:
a current collector comprising a first end portion and a second end portion facing away from the first end portion along a length direction of the current collector; and
an active layer on the current collector;
wherein the active layer comprises an active material, an amount of the active material in the active layer increases from the first end portion toward the second end portion along the length direction;
a second electrode plate; and
a separator sandwiched between the first electrode plate and the second electrode plate;
wherein the first electrode plate, the second electrode plate and the separator are wound along the length direction to form an electrode assembly; the electrode assembly comprises a center, the first end portion is located at an interior of the electrode assembly near the center, and the second end portion is located at an exterior of the electrode assembly away from the center.

11. The battery of claim 10, wherein a thickness of the active layer increases from the first end portion toward the second end portion.

12. The battery of claim 10, wherein the active layer further comprises thermally conductive material mixed with the active material, and an amount of the thermally conductive material in the active layer decreases from the first end portion toward the second end portion along the length direction.

13. The battery of claim 10, wherein the electrode plate further comprises a thermally conductive layer sandwiched between the active layer and the current collector, the thermally conductive layer comprises a thermally conductive material, and an amount of the thermally conductive material in the thermally conductive layer decreases from the first end portion toward the second end portion along the length direction.

14. The battery of claim 13, wherein a thickness of the thermally conductive layer decreases from the first end portion toward the second end portion along the length direction.

15. The battery of claim 10, wherein the current collector comprises a first surface and a second surface facing away from the first surface; and the first surface faces the center of the electrode assembly, and the second surface of the current collector faces away from the center of the electrode assembly.

16. The battery of claim 15, wherein the active layer comprises a first active layer formed on the first surface and a second active layer formed on the second surface;
an amount of the active material in the first active layer increases from the first end portion toward the second end portion along the length direction, an amount of the active material in the second active layer increases from the first end portion toward the second end portion along the length direction; and,
the amount of the active material in the first active layer on a corresponding area of the current collector is less than the amount of the active material in the second active layer on the corresponding area of the current collector.

17. The battery of claim 16, wherein each of the first active layer and the second active layer comprises a thermally conductive material mixed with the active material;
the thermally conductive material in the first active layer decreases from the first end portion toward the second end portion along the length direction, the thermally conductive material in the second active layer decreases from the first end portion toward the second end portion along the length direction; and
the amount of the thermally conductive material in the first active layer on a corresponding area of the current collector is greater than the amount of the thermally conductive material in the second active layer on the corresponding area of the current collector.

18. The battery of claim 16, wherein the electrode plate further comprises a first thermally conductive layer and a second thermally conductive layer;
the first thermally conductive layer is sandwiched between the first active layer and the first surface, the second thermally conductive layer is sandwiched between the second active layer and the second surface;
each of the first thermally conductive layer and the second thermally conductive layer comprises a thermally conductive material, an amount of the thermally conductive material in the first thermally conductive layer decreases from the first end portion toward the second end portion along the length direction, an amount of the thermally conductive material in the second thermally conductive layer decreases from the first end portion toward the second end portion along the length direction; and,
the amount of the thermally conductive material in the first thermally conductive layer on a corresponding area of the current collector is less than the amount of the thermally conductive material in the second thermally conductive layer on the corresponding area of the current collector.

19. The battery of claim 10, wherein a thickness of the active layer increases in a stepwise manner from an end of the active layer adjacent to the first end portion toward an end of the active layer adjacent to the second end portion along the length direction.

20. The battery of claim 10, wherein the electrode assembly comprises a first circle and a second circle extend from an end portion of the first circle along the length direction X;
an amount of the active material of any region of the electrode plate in the first circle of the electrode assembly is the same;
an amount of the active material of any region of the electrode plate in the second circle of the electrode assembly is the same; and
the amount of the active material in the first circle of the electrode assembly is different from the amount of the active material in the second circle of the electrode assembly.
